(19) United States
(12) Patent Application Publication
(10) Pub. No.: US 2011/0256360 A1
(43) Pub. Date: Oct. 20, 2011

(54) REUSABLE BODY DECORATION

(76) Inventor: DAN JEFFERY, San Juan Capistrano, CA (US)

(21) Appl. No.: 12/763,719

(22) Filed: Apr. 20, 2010

(51) Int. Cl. B32B 3/00

(52) U.S. Cl. 428/195.1

(57) ABSTRACT

A reusable body decoration includes a decorative member, a multilayer adhesive adhered to one side of the decorative member, the multilayer adhesive having a first layer having a relatively low peel strength for removably contacting a user's skin and a second layer having a relatively high peel strength for contacting one side of the decorative member, the first and second layer being laminated.

Decoration of the human body by applying paint, makeup, mask, or details has been common place throughout human existence. In fact, artistic decoration of the human body has been desired by the human population for centuries and is still present today. This is evidenced by the popularity of tattoos.

Modern tattoos utilize needles to inject dyes and pigments in subcutaneous patterns which are visible. However, this process is both painful, costly, and the image is permanent with the exception of painful and costly removal.

Temporary body decoration is prevalent during Halloween periods and at many social gatherings which includes sports and other festivities in which fans or participating individuals desire to either distinguish themselves or exhibit allegiance with a group of people.

Accordingly, for such purposes, any reusable body decoration is desirable if individual desires to attend multiple events. The present invention provides for such a reusable body decoration.

### SUMMARY OF THE INVENTION

A reusable body decoration in accordance with the present invention generally includes a decorative member along with a multilayer adhesive adhered to one side of the decorative member. The multilayer adhesive includes a first layer having a relatively low strength for removably contacting a user's skin and a second layer having a relatively high peel strength for contacting one side of the decorative member. The first and second layers may be laminated and the difference in peel strengths enables the reuse of the decoration by serial application to body part without separation of the adhesive from the decorative member.

Preferably, the decorative member is generally planer and conformable to the user's skin or body contour.

A visible image may be disposed on another side of the decorative member or alternatively the decorative member may be transparent and the decoration further comprises a visible image disposed on the one side of the decorative member between the decorative member and the adhesive layers. In one embodiment of the present invention, the decorative member and the multilayer adhesive have a common perimeter.

Alternatively, the decoration in accordance with the present invention may further include a sticker, tape, or decal having an image thereon which is disposable on another side of the decorative member. At this instance, it may be preferable provide another side of the decorative member with a porous structure thus providing a surface for adherence of the sticker tape or decal.

More specifically, the decoration in accordance with the present invention includes first and second layers each of which comprise a monomeric mixture having about 12 to about 70 pph acrylic acid, about 0.5 to about 30 pph N-vinylpyrolidone and about 0.01 to about 8 pph of a thickening agent comprising N-vinylpyrolidone/vinyl acetate copolymer and the first layer comprises more glycerol than the second layer, each layer further comprising a humectant in different amounts in order to the difference in peel strength.

More particularly, the decoration multilayer adhesive may include different cross-linking agents in each of the first and second layers and the humectant may comprise a polyhydric alcohol.

In addition, each of the adhesive layers may include a humectant at different amounts in order to provide the difference in peel strength with the humectant being present in the first layer and an amount greater than in the second layer.

### BRIEF DESCRIPTION OF THE DRAWINGS

The advantages and features of the present invention will be better understood by the following description when considered in conjunction with the accompanying drawings in which:

FIG. 1 is a cross sectional view of one embodiment of the present invention and generally illustrating a decorative member with a multilayer adhesive adhered to one side of the decorative member;

FIG. 2 is an illustration of the use of the body decoration illustrated in FIG. 1;

FIG. 3 is an alternative embodiment of the present invention in which the decorative member is transparent and the decoration further includes a visible image disposed on the one side of the decorative member adjacent the multilayer adhesive; and

FIG. 4 is an illustration of yet another embodiment of the present invention in which a sticker, tape, or decal is disposed on another side of the decorative member.

### DETAILED DESCRIPTION

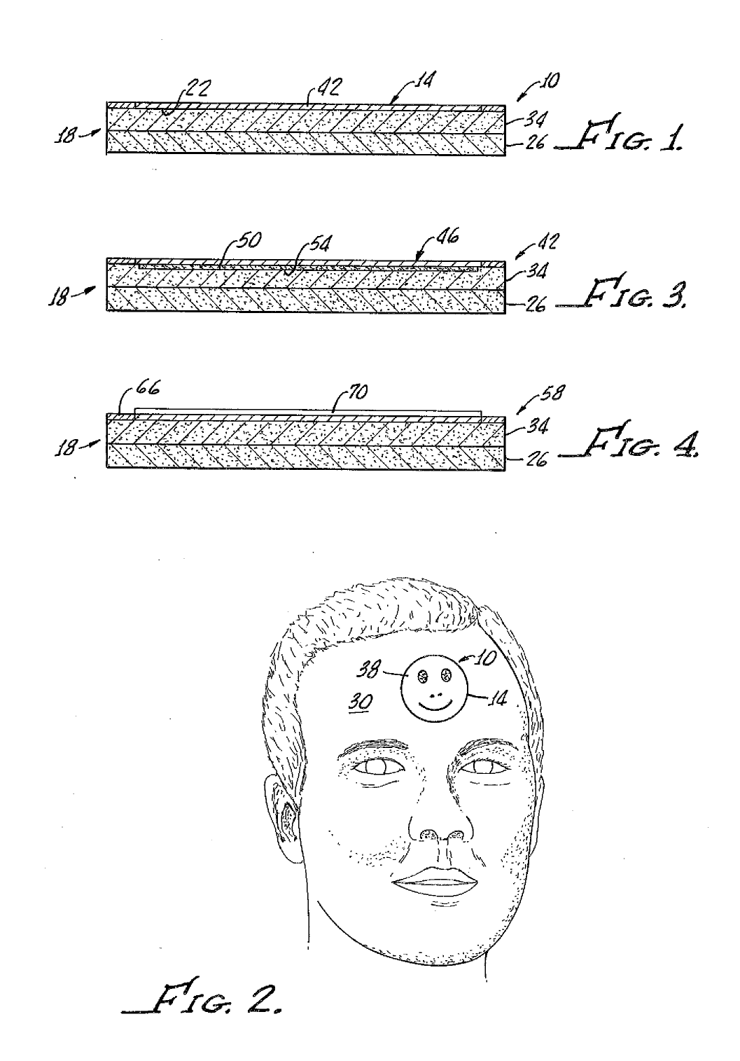

With reference to FIGS. 1 and 2, there is shown a reusable body decoration 10 which includes a decorative member 14 along with a multilayer adhesive 18 adhered to one side 22 of the decorative member 14.

The multilayer adhesive 18 includes a first layer 26 having a relatively low peel strength for removal to a contacting a user's skin 30, see FIG. 2, and a second layer 34 having a relatively high peel strength for contact the one side 22 of the decorative member 14 as illustrated in FIG. 1.

As shown, the decoration 10 is generally planer but conformable to the user's skin, as illustrated in FIG. 2.

As also illustrated in FIG. 2, the decoration 10 may include a visible image disposed on another side 42 of the decorative member 14. As illustrated in FIG. 1, the decorative member 14 and the multilayer adhesive 18 may have a common perimeter.

An alternative embodiment decoration 42 is illustrated in FIG. 3 with common reference characters indicating identical or substantially similar components. In this decoration 42, the decorative member 46 is transparent and the decoration 42 further comprises a visible image 50 disposed on one side 54 of the decorative member 46. In this manner, the transparent decorative member 46 protects the image 50 from any deterioration due to sun or moisture in the environment.

Yet another embodiment decoration 58 is illustrated in FIG. 4 with common reference characters indicating identical or substantially similar components, as hereinbefore described.

In this embodiment 58, the decorative member 62 may include a porous surface to facilitate adherence of a separate sticker, tape, or decal 70 having an image thereon.

The multilayer adhesive 18 includes layers 26, 34 include organic polymers derived from the copolymerization of a mixture of monomeric acrylic acid and N-vinyl-pyrrolidone. These polymers are set forth in U.S. Pat. Nos. 5,868,136 and 6,263,226 which are incorporated herewith in toto to describe generally suitable polymers. For example, in general layers 26, 34, the organic polymer may comprise 25 to 75 parts per hundred, by weight (pph), e.g. 30 to 60 pph, acrylic acid and 2 to 30 pph, e.g., 10 to 30 pph, N-vinylpyrrolidone.

Furthermore, the orgianic polymer may comprise, e.g., 0.1 to 6 pph, e.g., about 2 pph, of a sulfonic acid-containing comonomer to (promote adhesion of the substrate), such as 2-acrlamide propane sulfonic acid (AMPS) and from, e.g., 0.1 to 5 pph, e.g., about 0.5 to 1.5 pph of a cross-linking agent, such as methylene-bis-acrylamide, to increase to molecular weight and cohesivity of the conductive organic polymer through crosslinking. Other comonomers having at least two copolymerizabel olefinic moieties, especially difunctional derivatives of acrylic acids, may be utilized in place of the preferred methylene bis-acrylamide, for example, tripropylene bis-methacylate, and diethylene glycol diacrylate.

The comonomer mixture may include both methylene-bis-acrylamide and acrylamide.

The comonomer mixture that is copolymerized to provide the organic polymer may also include a polyhydric alcohol, e.g., polyhydroxyhydrocarbons and oxyalkyls, e.g. ethyleneglyco, diethyleneglyco, glycerol, etc. to plasticize the organic polymer. The polyhydric functions as a humectant, i.e., it absorbs moisture and promotes conductivity of the substrate 15. The polyhydric alcohol may comprise from 25 to 75 pph, preferably from 40 to 60 pph, e.g., about 37 to 53 pph of the comonomer mixture. Most preferably, the polyhydric alcohol is glycerol.

To comonomer mixture that is copolymerized to provide the conductive organic polymer may also include a thickening agent. The thickening agent may be a high molecular weight polymer or copolymer such as a methylvinylether/maleic acid copolymer (Gantrez® S95), which is available from ISP, ethylene/maleic anhydride (EMA Copolymer), which is available from Zeeland Chemical, and N-vinylpyrrolidone/acrylic acid Acrylidone® (ACP-1041), which is available from ISP, 0.5 to 8 pph of the comonomer mixture, e.g., about 2 to 5 pph.

The above comonomer mixture is preferably copolymerized or cured by thermal, chemical redox, or radiation, particularly, ultraviolet (UV) radiation. Therefore, an ultraviolet sensitive curing agent is provided in the comonomer mixture at a concentration of from 0.05 to 3 pph, preferably from 0.5 to 2.0 pph. Suitable curing agents are 2-hydroxy-2-methyl-1-phenyl-propan-2-one (available as Darocur 11730®), 4-(2-hyroxyethoxy)phenyl (2-hydroxy-2-phenyl-(2-hydroxy-2-propyl)ketone (available as Darocur 2959™), or 2,2-dimethoxy-2-phenyl acetophenone (available as Irgacure® 651), all of which are available from Ciba-Geigy.

It should be appreciated that the peel strength of the first layer 26 contacting the skin 30 should be relatively low (i.e., up to about 100 grams/cm) in order to provide adequate release of the decoration 10 from the skin 30 whereas the second layer 34 should have a relatively high peel strength (i.e., over about 250 grams/cm) in order to insure permanent contact with the decorative member 14.

Peel strength as used herein is defined as the amount of force necessary to peel a 2.5 cm strip of gel at 180° from a surface at the rate of 30 cm per min.

Improved skin adhesion of the first layer 26 occurs when the acrylic acid component is in the 10 to 15% range. For the second layer 34 improved adhesion occurs when the acrylic acid component is in the high end of the range (20 to 30%). In order for the skin 30 adhesion to the first layer 26 to be non-“tape-like” or non-stringy (both undesirable for removal or repositioning of gel), water and plasticizer (glycerin, PEG, etc.) have to be high. However, the second layer 34 adhesion without creep or crawl, the plasticizer and water must be low.

The choice of crosslinking monomer and initiator also both result in dramatically differing physical attributes to an otherwise similar gel formula. For example, monomers in the polyethylene glycol or polypropylene glycol diacrylate family (i.e., with polyethylene glycol or polypropylene glycol groups between the acrylic groups) contribute to high adhesion and cure rates but lack skin-wise preferably traits such as wetness and repositionability.

Accordingly, these crosslinking monomers are desirable for use in the second adhesion layer 34.

For the first layer 26, the polyethylene or polypropylene glycol dimethacrylate family have been found to contribute softness, wetness, non-tape like peel, non-stringy peel, and excellent repositionability. In particular, a combination of diethylene glycol diacrylate in the substrate adherent gel layer and tripopylene glycol bis-methacrylate in the first layer 36 has been found to be extremely effective in providing a high performance substrate adherent layer on the different substrates listed above but have outstanding skin side attributes including non-stringy peel and multiple repositionability.

Table 1 provides gellable comonomer mixtures optimized for first and second layers 26, 34 as well as a broad range of ingredients from which they are derived.

TABLE 1

| | Broad | First | Second |
|---|---|---|---|
| Ingredient | Range pph | Layer pph | Layer pph |
| acrylic acid | 15-30 | 12.5 | 22 |
| n-Vinylpyrrolidone | 0.5-15 | 6 | 12.5 |
| acrylamide | 0-10 | 1.5 | 6 |
| methylene-bis-acrylamide | 0.01-2 | .18 | .12 |
| AMPS | 0.1-6 | 2.5 | 0 |
| thickener | 0.5-8 | 2.5 | 1.0 |
| glycerin | 25-75 | 48 | 40 |
| UV sensitive curing agent | 0.05-3 | .13(2959) | .20(1173) |
| distilled water | 5-25 | 26.7 | 18.2 |

Although there has been hereinabove described a specific reusable body decoration in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A reusable body decoration comprising:
a decorative member;
a multilayer adhesive adhered to one side of said decorative member, said multilayer adhesive having a first layer having a relatively low peel strength for removably contacting a user's skin and a second layer having a relatively high peel strength for contacting one side of said decorative member, the first and second layer being laminated.

2. The decoration according to claim 1 wherein said decorative member is planer and conformable to the user's skin.

3. The decoration according to claim 1 further comprising a visable image disposed on another side of said decorative member.

4. The decoration according to claim 1 wherein said decorative member is transparent and the decoration further comprises a visable image disposed on the one side of said decorative member.

5. The decoration according to claim 1 wherein said decorative member and said multilayer adhesive have a common perimeter.

6. The decoration according to claim 1 further comprising a sticker, tape, or decal, having an image thereon, disposable on another side of said decorative member.

7. The decoration according to claim 6 wherein said another side decorative member is porous for providing a surface for adherence of the sticker, tape, or decal.

8. The decoration according to claim 1 wherein the first and second adhesive layers each comprise a monomeric mixture having about 12 to about 70 pph acrylic acid, about 0.5 to about 30 pph N-vinylpyrolidone and about 0.01 to about 8 pph of a thickening agent comprising N-vinylpyrolidone/vinyl acetate copolymer and the first layer comprises more glycerol than the second layer, each layer further comprising a humectant in different amounts in order to the difference in peel strength.

9. The decoration according to claim 8 further comprising different cross-linking agents in each of the first and second layers.

10. The decoration according to claim 8 wherein said humectant comprises polyhydric alcohol.

11. The decoration according to claim 10 wherein each layer further comprises a humectant in different amounts in order to provide the difference in peel strength with the humectant being present in the first layer an amount greater than in the second layer.

12. The decoration according to claim 11 wherein said humectant comprises polyhydric alcohol.
